(19) United States
(12) Patent Application Publication
(10) Pub. No.: US 2006/0248107 A1
(43) Pub. Date: Nov. 2, 2006

(54) Apparatus system and method for updating software while preserving system state

(76) Inventors: Juan Alonso Coronado, Tucson, AZ (US); Angelica M. Hemme, Vail, AZ (US); Bret Wayne Holley, Tucson, AZ (US); Ricardo Sedillos Padilla, Tucson, AZ (US)

Correspondence Address: KUNZLER & ASSOCIATES, 8 EAST BROADWAY, SUITE 600, SALT LAKE CITY, UT, 84111, US

(21) Appl. No.: 11/103,278

(22) Filed: Apr. 11, 2005

(51) Int. Cl. G06F 7/00; G06F 17/00

(52) U.S. Cl. 707/102

(57) ABSTRACT

An apparatus, system, and method are disclosed for updating software components while preserving data associated with the software and optionally converting the data to a new format. Persistent memory is used to preserve data structures associated with software components during the software update process, which may be accomplished by save and restore functions intrinsic to the software component being updated. The present invention includes, in one embodiment, a persistent data registry used to register each data structure saved in persistent memory during a software update. A data structure information record may be used to register each data structure in the persistent data registry. The present invention incorporates individual conversion of each data structure to facilitate adding, deleting, or modifying data structures during the software update process to accommodate the requirements of the updated software.

### BACKGROUND OF THE INVENTION

1. Field of the Invention

This invention relates to updating computer software and more particularly relates to updating computer software while preserving system state.

2. Description of the Related Art

Many computer operating environments require nearly continuous uptime. Advances in computer hardware have achieved levels of reliability approaching continuous uptime. Software has lagged behind hardware, but the quest for increased reliability continues. One obstacle to the achievement of continuous uptime is system maintenance. For example, systems frequently need to be brought offline or rebooted when software or firmware is updated. The problem of trying to update computer system software or firmware without an interruption in computer services has been compared to performing maintenance on jet engines while the jet is in flight.

Some systems save their system state previous to conducting a software update. Such systems enable software to resume processing while retaining valuable state information such as account balances. However, if the software uses a new format for representing data due to changes in the internal data structures, the preserved data must typically be converted to the new format before the system state information maybe restored. Typically, conversion of the old data to a new format requires execution of a standalone conversion utility causing additional down-time when conducting a software update.

From the foregoing discussion, it should be apparent that a need exists for an apparatus, system, and method that automatically update computer software while preserving system state. Beneficially, such an apparatus, system, and method would facilitate transparent modification of data structures associated with a software module during an update procedure and thereby increase reliability and uptime.

### SUMMARY OF THE INVENTION

The present invention has been developed in response to the present state of the art, and in particular, in response to the problems and needs in the art that have not yet been fully solved by currently available software update systems. Accordingly, the present invention has been developed to provide an apparatus, system, and method for updating software while preserving system state that overcome many or all of the above-discussed shortcomings in the art.

The apparatus to update software while preserving system state is provided with a logic unit containing a plurality of modules configured to functionally execute the necessary operations for updating software in a transparent manner. These modules in the described embodiments include an image update module configured to update a code image and one or more software components comprising a save function and a restore function. In the described embodiments, the save function preserves persistent data, and the restore function restores the software component to a valid processing state using the persistent data. The restore function is further configured to convert data in an obsolete format to a current format thus eliminating the need for a separate data conversion process.

The apparatus, in one embodiment, includes a persistent memory configured to preserve data structures during a software update. Data structures pertaining to one or more software component may be copied to the persistent memory during a software update. When the software update is complete, the data structures may be restored to the software components from which they were copied. Restoring data structures may further include converting the data structures from an obsolete format to a current format.

The apparatus, in one embodiment, also includes a persistent data registry configured to identify data structures that are to be preserved during a software update. In one embodiment, the persistent data registry is a dedicated portion of a system registry provided by an operating system. The image update module may access the persistent data registry to register and/or identify data structures preserved in the persistent memory during a software update. In one embodiment, a data structure information record is stored in the registry for each data structure that is to be preserved.

In one embodiment, the data structure information record includes a unique identifier, a software component identifier, a pointer to the data structure to be preserved, the size of the data structure, and a pointer to a buffer in the persistent memory. The data structure information records may be preserved in the persistent data registry during a software update. In one embodiment, the persistent data registry is a portion of the persistent memory allocated as a registry.

A method of the present invention is also presented for updating software while preserving system state. The method in the disclosed embodiments substantially includes the operations necessary to carry out the functions presented above with respect to the operation of the described apparatus and system. In one embodiment, the method includes receiving a signal to prepare for a software update, querying one or more components to identify data structures to be preserved, copying data structures to a persistent memory, registering the preserved data structures, loading an updated code image into memory, restoring data structures from a persistent memory, and branching to the updated code image. Many of the operations of described method maybe conducted concurrently by multiple software components involved in an update.

In a further embodiment, the method includes converting data structures from an obsolete format to a current format. Operations associated with converting data structure format may include deleting unneeded data structures, restoring needed data structures, and transforming data structures in need of modification.

Reference throughout this specification to features, advantages, or similar language does not imply that all of the features and advantages that maybe realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a software update system in accordance with the present invention;

FIG. 2 is a schematic block diagram illustrating one embodiment of a data structure information record in accordance with the present invention;

FIG. 3 is a schematic flow chart diagram illustrating one embodiment of a data structure save method in accordance with the present invention;

FIG. 4 is a schematic flow chart diagram illustrating one embodiment of a data structure restore method in accordance with the present invention; and

FIG. 5 is a schematic flow chart diagram illustrating one embodiment of a software update method in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams that follow are generally set forth as logical flow chart diagrams. As such, the depicted order and labeled operations are indicative of one embodiment of the presented method. Other operations and methods may be conceived that are equivalent in function, logic, or effect to one or more operations, or portions thereof, of the illustrated method. Additionally, the format and symbols employed are provided to explain the logical operations of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated operations of the depicted method. Additionally, the order in which a particular method occurs may or may not strictly adhere to the order of the corresponding operations shown.

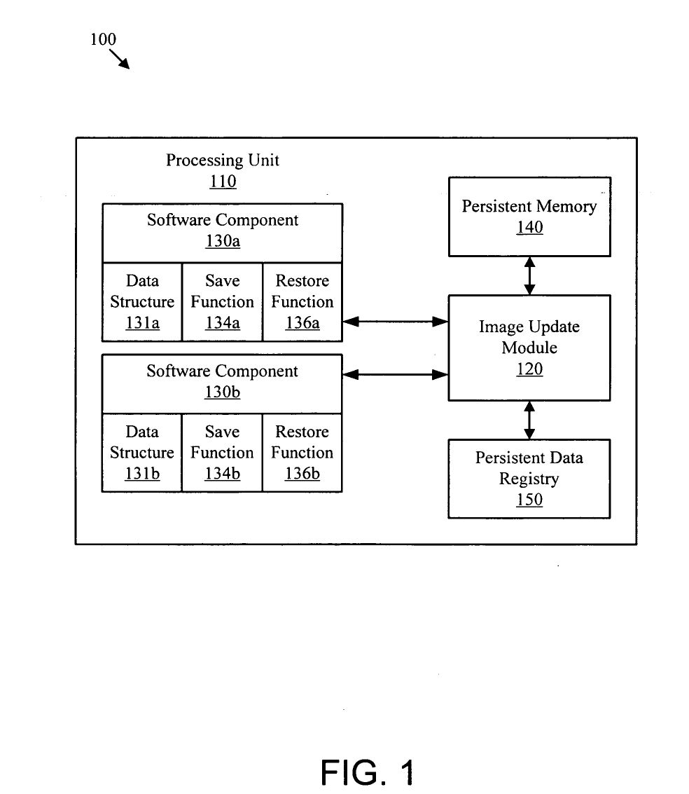

FIG. 1 is a schematic block diagram illustrating one embodiment of a software update system 100 in accordance with the present invention. The software update system 100 includes a processing unit 110, an image update module 120, at least one software component 130, at least one data structure 131, a save function 134, a restore function 136, a persistent memory 140, and a persistent data registry 150.

The software update system 100 facilitates updating the software component 130 and preserving the data in each data structure 131 throughout the software update process. The software update system 100 also facilitates modifying a data structure 131 when updating a software component 130. In various embodiments, fields in a data structure 131 are preserved, added, and deleted when updating a software component 130.

In certain embodiments, the image update module 120 prepares for updating each software component 130 by invoking a save function 134 associated with each software component. In one embodiment, each save function may use the persistent memory 140, and the persistent data registry 150 to save state information relevant to the software component 131.

The image update module 120 may update one or more old software components 130a to a current software component 130b and invoke a restore function 136 associated with the current software component 130b to restore the state information associated with that component. The restore function 136 may also identify obsolete data structures 131a within the persistent memory 140 that are relevant to the software component 130 and convert each obsolete data structure 131a to a current data structure 131b.

The described elements of the software update system 100 may operate under control of the processing unit 110. In one embodiment, the processing unit 110 is a computer. In another embodiment, the processing unit 110 is an adapter, such as an adapter for a peripheral device. The processing unit may provide a code image to the image update module 120 to update each software component 130.

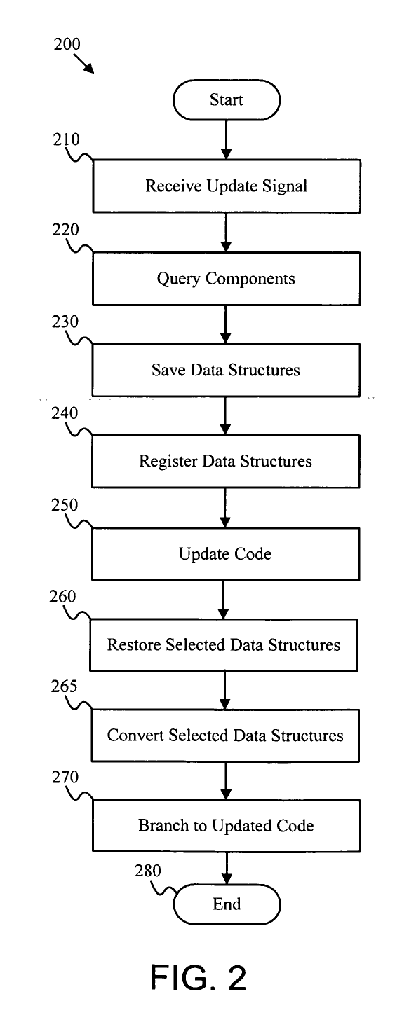

In the depicted embodiment, the image update module 120 updates each software component 130 in conjunction with a software update method such as the software update method 200 depicted in FIG. 2. In some embodiments, the image update module 120 receives a signal from the processing unit 110 to prepare for a code update along with an updated code image for a software component 130. The image update module 120 in conjunction with the save functions 134, may save selected data structures 131 within the persistent memory 140 previous to updating the software component 130 and registering each data structure 131 in the persistent data registry 140. After updating the software component 130, each saved data structure 131 may be restored from the persistent memory 140.

The software update system typically comprises several software components 130, but for illustrative purposes only one obsolete software component 130a and one updated software component 130b are depicted. In one embodiment, the software component 130 comprises software instructions for controlling the operation of a computer or the like. In another embodiment, the software component comprises microcode for controlling the operation of an adapter, such as an adapter for a peripheral device.

A software component 130 typically comprises several data structures 131, but for illustrative purposes only one obsolete data structure 131 a and one updated data structure 131b are depicted. When updating a software component 130, it is typically advantageous to preserve data throughout and beyond the update process. For example, a software component 130 may use a data structure 131 to store configuration settings or user preferences or the like. In some embodiments, a software component 130 may use a data structure 131 to store configuration settings associated with an adapter, such as an adapter for a peripheral device. By preserving the data structures 131, the software update system 100 facilitates continuous operation of the processing unit 110 during a software update.

In the depicted embodiment, the software component 130 is a software object common to object-oriented software and the save function 134 and restore function 136 are specific methods of the software component 130. The save function 134 facilitates saving the data structures 131 in accordance with the data structure save method 300 or the like. As depicted in FIG. 1, the save function 134 is part of the software component 130, and therefore an obsolete save function 134a may be updated with a modified save function 134b during the software update process.

The restore function 136 restores data structures 131 in accordance with the data structure restore method 400 or the like. An obsolete restore function 136a may be updated with a modified restore function 136b during the software update process. In various embodiments, the restore function 136 may restore a data structure 131 unmodified, modify a data structure 131 by adding or deleting fields, modify a data structure 131 by altering data in one or more fields, or by deleting a data structure 131.

The save function 134 and the restore function 136 may be invoked during normal operation to save and restore system state information even if no software update is to occur. For example, the save function 134 may be invoked in conjunction with a shutdown procedure and the restore function 136 may subsequently be invoked in conjunction with bootup procedure. In the depicted embodiment, the save functions 134 and the restore functions 136 save and restore only that data that is relevant to the software component 130. Distributing the save and restore operations in the depicted arrangement, reduces the complexity of developing and maintaining the code that performs the actual operations.

The persistent memory 140 preserves data structures 131 while a software component 130 is being updated. In one embodiment, the persistent memory 140 is a dedicated region within a non-volatile storage device. In another embodiment, the persistent memory 140 is dedicated allocation of virtual memory that is associated with a non-volatile storage device.

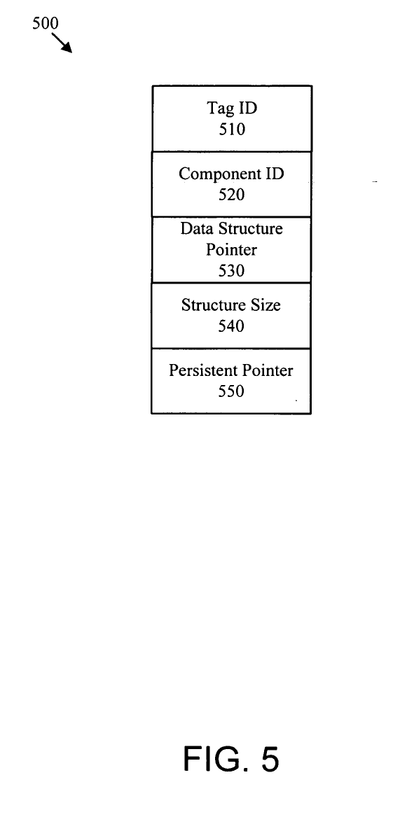

The image update module 120 in accordance with the save functions 134 may save the data structures 131 in the persistent memory 140 before updating the software component 130. For each data structure 131 saved in the persistent memory 140, the image update module 120 may create a data structure information record in the persistent data registry 150. One embodiment of a data structure information record is depicted in FIG. 5.

FIG. 2 is a schematic flow chart diagram illustrating one embodiment of a software update method 200 in accordance with the present invention. The software update method 200 in certain embodiments includes a receive update signal operation 210, a query components operation 220, a save data structures operation 230, a register data structures operation 240, an update code operation 250, a restore selected data structures operation 260, a convert selected structures operation 265, and a branch to updated code operation 270. The software update method 200 updates at least one software component 130, preserving the contents of at least one data structure 131. The software update method 200 may also facilitate converting a data structure 131 from an obsolete format to a current format during a software update.

The depicted embodiment of the software update method 200 begins with the receive update signal operation 210. The receive update signal operation 210 receives a signal to prepare to update one or more software components 130. In one embodiment, the image update module receives an update signal from another component executing on the processing module 110. In some embodiments, the receive update signal operation 210 includes receiving updated code for the software components 130.

Some embodiments of the present invention include the query components operation 220. The query components operation 220 queries the software component 130 that is to be updated to determine which data structures 131 are to be preserved during the software update. In one embodiment, the query components operation 220 comprises invoking the save function 134.

The save data structures operation 230 copies at least one data structure 131 to the persistent memory 140. In one embodiment, the save data structures operation 230 copies one or more data structures 131 directly to the persistent memory 140 and invokes a function to register the data structures 131 within the persistent data registry 150 in conjunction with the register data structures operation 240.

The register data structures operation 240 facilitates updating and restoring at least one data structure 131 by recording data describing the copy of the data structure 131 in the persistent memory 140. The register data structures operation 240 typically identifies the data structure 131, the software component 130 that the data structure 131 is associated with, and the location in the persistent memory 140 that the data structure 131 was copied to. In one embodiment, the register data structures operation 240 uses a data structure information record 500 to register the data structure 131 in the persistent data registry 150.

The update code operation 250 updates one or more software components 130. In one embodiment, the processing unit 110 provides an updated code image for the software component 130. The image update module 120 updates the software component 130 with the updated image. The software component 130 may include one or more updated data structures 131. In various embodiments, the updated data structures 131 may be unchanged or may be modified in various ways, such as by including new data fields, having data fields deleted, or by having data fields contain data transformed by type, range of values, or the like.

The restore selected data structures operation 260 restores data structures 131 from the persistent memory 140. In one embodiment, the image update module 120 uses data structure information records 500 in the persistent data registry 150 to locate each data structure 131 in the persistent memory 140 and copy the data structure 131 to its location in the associated software component 130. In some embodiments, the restore selected data structures operation 260 consists of executing the restore function 136.

In various embodiments, the restore function 136 may also conduct the convert selected data structures operation 265. The convert selected data structures operation 265 may initialize new data fields with default values, transform data fields by data type or the like or delete selected data fields. In one embodiment, conversion of the selected data structures occurs within the working memory of the software component 130.

The branch to updated code operation 270 initiates execution of the updated software component 130 by branching to the initial instruction of the updated software component 130. In some embodiments, the branch to updated code operation 270 may initialize processor registers, push a return address onto a processor stack, or the like.

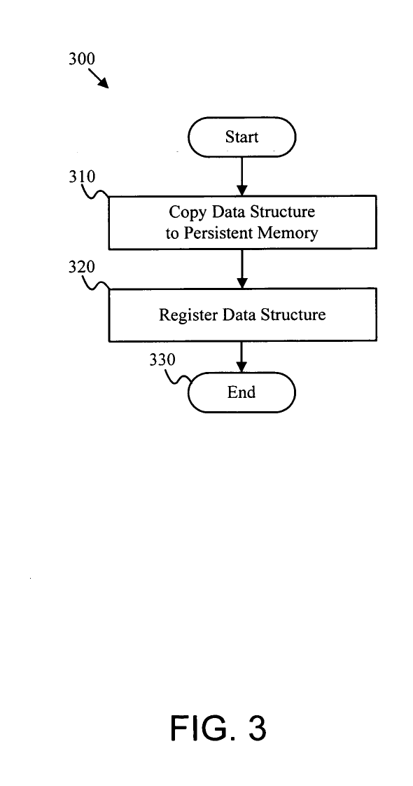

FIG. 3 is a schematic flow chart diagram illustrating one embodiment of a data structure save method 300 in accordance with the present invention. The data structure save method 300 includes a copy data structure operation 310, and a register data structure operation 320. The data structure save method 300 preserves data structures 131 in the persistent memory 140 during the code update process. In one embodiment the data structure save method 300 is the save function 134 of the software component 130.

The embodiment of the data structure save method 300 depicted in FIG. 3 begins with the copy data structure operation 310. In some embodiments, the copy data structure operation 310 is performed by the image update module 120 in accordance with the save function 134. The copy data structure operation 310 copies data structures 131 from the software component 130 to the persistent memory 140.

The data structure save method 300 continues with the register data structure operation 320. The register data structure operation 320 registers a data structure 131 by creating a data structure information record such as the record 500 depicted in FIG. 5 and entering the appropriate values in the record's fields. Registering a data structure 131 may include assigning values identifying the software component 130 the data structure 131 originated from, recording the location of the data structure 131 in the software component 130, recording the size of the data structure 131, and recording the location in the persistent memory 140 where the data structure 131 is to be saved during the software update process. After completing the register data structure operation 320, the data structure save method 300 ends 330.

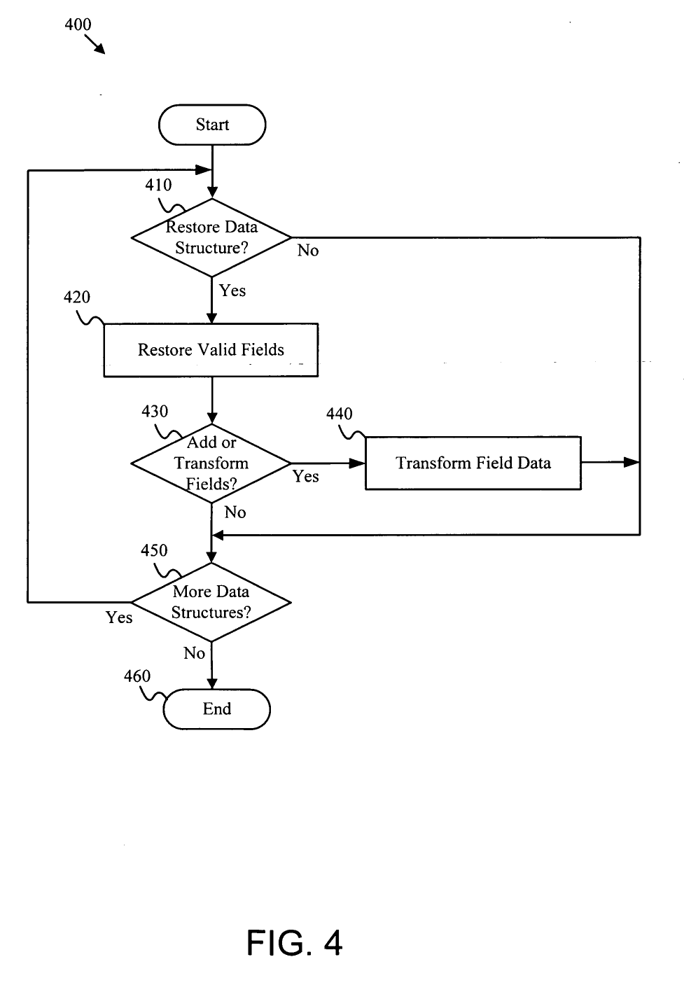

FIG. 4 is a schematic flow chart diagram illustrating one embodiment of a data structure restore method 400 in accordance with the present invention. The data structure restore method 400 includes a restore data structure test 410, a restore valid fields operation 420, an add or transform fields test 430, a transform field data operation 440, and a more data structures test 450. The data structure restore method 400 is used to restore data structures 131 saved in the persistent memory 140. In one embodiment, the data structure restore method 400 is the restore function 136 in a software component 130.

The embodiment of the data structure restore method 400 depicted in FIG. 4 begins with the restore data structure test 410. The restore data structure test 410 determines whether a data structure 131 is to be restored from the persistent memory 140. An updated software component 130 may not use the same data structures 131 as the previous version of the software component 130. In such cases, the data structure restore method 400 deletes obsolete data structures 131 simply by not restoring them from the persistent memory 140. In one embodiment, the image update module 120 queries a software component 130 to determine whether data structures 131 registered in the persistent data registry 150 are to be restored from the persistent memory 140. In another embodiment, the restore function 136 of a software component 130 contains a list of one or more data structures 131 be restored from the persistent memory 140. If the data structure 131 is to be restored, the data structure restore method 400 continues with the restore valid fields operation 420. Otherwise, the data structure restore method 400 continues with the more data structures test 450.

The restore valid fields operation 420 restores fields pertaining to a data structure 131 from the persistent memory 140. Updating a software component 130 may require one or more data structures 131 to be modified. Modifying a data structure 131 may include deleting fields, adding fields, and transforming data within a field. Fields of a data structure 131 that are not to be deleted or transformed contain valid data and are restored from the persistent memory 140. Fields to be deleted from a data structure 131 are simply not restored from the persistent memory 140. In the embodiment depicted in FIG. 4, initialization of new fields and transformation of data in existing fields are handled by the add or transform field data operation 440.

The add or transform fields test 430 determines whether modifications are to be made to fields of a data structure 131 being restored from the persistent memory 140. Modifications may include initializing data in a field being added to a data structure 131 and transformations of data in an existing field of a data structure 131. If modifications are to be made to the data structure 131, the data structure restore method 400 continues with the transform field data operation 440. Otherwise, the data structure restore method 400 continues with the more data structures test 450.

The transform field data operation 440 transforms data in fields of a data structure 131. The transform field data operation 440 may initialize a field being added to a modified data structure 131 to a default value. The transform field data operation 440 may also modify the value contained in a field according to data type or the like. For example, an updated software component 130 may use an unsigned integer counter where the previous version of the software component used a signed integer. In this example, the transform field data operation 440 converts the signed integer value saved in the persistent memory 140 to the equivalent unsigned integer value and saves the transformed value in the appropriate field of the data structure 131.

The more data structures test 450 determines whether more data structures 131 pertaining to the software component 130 are to be restored from the persistent memory 140. In one embodiment, the more data structures test 450 may poll the software component 130 to determine whether a data structure 131 registered in the persistent data registry 150 is to be restored. In another embodiment, the restore function 136 of a software component 130 contains a list of data structures 131 to be restored from the persistent memory 140. If more data structures 131 are to be restored, the data structure restore method 400 continues with the restore data structure test 410. Otherwise the data structure restore method 400 ends 460.

FIG. 5 is a schematic block diagram illustrating one embodiment of a data structure information record 500 in accordance with the present invention. The data structure information record 500 includes a tag ID 510, a component ID 520, a data structure pointer 530, a structure size 540, and a persistent memory pointer 550. In one embodiment of the present invention, the image update module 120 uses a data structure information record 500 to register a data structure 131 in the persistent data registry 150 when it is copied to the persistent memory 140 during an update of a software component 130.

The tag ID 510 identifies the data structure 131 that is registered in the persistent data registry 150 for storage in the persistent memory 140 during a software update. In one embodiment, unique identification of a data structure 131 is achieved by combining the tag ID 510 identifying the data structure 131 within the software component 130 identified by the component ID 520. The tag ID 510 may also incorporate a data structure version number that enables the software update system 100 to verify compatibility.

The component ID 520 uniquely identifies the software component 130 with which a data structure 131 is associated. The component ID 520 may incorporate encoded information identifying the manufacturer of a software component 130, a version number, or the like.

The data structure pointer 530 points to the memory location assigned to a data structure 131. In one embodiment, the data structure pointer 530 is used to copy a data structure 131 from the persistent memory 140 subsequent to a software update. In one embodiment, the data structure pointer 530 may consist of an identifier that uniquely identifies the data structure 131 to the restore function 136. The restore function 136 may use the data structure pointer 530 to identify the memory allocated for the data structure 131.

The structure size 540 records the size of the data structure 131 stored in the persistent memory 140. In one embodiment, the structure size 540 specifies the amount of data to be copied from the persistent memory 140 when restoring a data structure 131 subsequent to a software update.

The persistent memory pointer 550 specifies the location in the persistent memory 140 where a data structure 131 has been copied for storage during a software update. The persistent memory pointer 550 may be set either by the save function 134 of a software component 130 or by the image update module 120 in preparation for a software update.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for updating software while preserving system state, the apparatus comprising:
an image update module configured to update a code image; and
at least one software component, the software component comprising:
a save function configured to initiate preservation of persistent data, and
a restore function configured to restore the software component to a valid processing state using the persistent data, the restore function further configured to convert data in an obsolete format to a current format.

2. The apparatus of claim 1, further comprising a persistent memory configured to preserve data structures during a software update.

3. The apparatus of claim 1, wherein the image update module further comprises a persistent data registry configured to identify data structures to be preserved during a software update.

4. The apparatus of claim 3, further comprising at least one data structure information record, the data structure information record comprising:
a unique identifier;
a persistent data location; and
a persistent data size.

5. A system for updating software while preserving system state, the system comprising:
an image update module configured to update a code image;
at least one software component, the software component comprising:
a save function configured to initiate preservation of persistent data; and
a restore function configured to restore the software component to a valid processing state using the persistent data, the restore function further configured to convert data in an obsolete format to a current format; and
a processor configured to execute the code image.

6. The system of claim 5, further comprising a persistent memory configured to preserve data structures during a software update.

7. The system of claim 5, further comprising a persistent data registry configured to data structure information records to be preserved during a software update.

8. The system of claim 7, further comprising at least one data structure information record, the data structure information record comprising:
a unique identifier;
a persistent data location; and
a persistent data size.

9. The system of claim 5, wherein the software component comprises microcode configured to control a device adapter.

10. A method for updating software while preserving system state, the method comprising:
copying selected data structures to a persistent memory;
registering the selected data structures;
loading an updated code image into memory;
restoring the data structures from a persistent memory; and
converting at least one data structure to a current format.

11. The method of claim 10, wherein loading data structures from a persistent memory comprises invoking a restore function associated with a software component.

12. The method of claim 10, further comprising branching to the updated code image.

13. The method of claim 10, further comprising registering the selected data structures.

14. The method of claim 10, wherein converting at least one data structure to a current format comprises deleting at least one field.

15. The method of claim 10, wherein converting at least one data structure to a current format comprises modifying at least one field.

16. A signal bearing medium tangibly embodying a program of machine-readable instructions executable by a digital processing apparatus to perform an operation for updating software while preserving system state, the operation comprising:
copying selected data structures to a persistent memory;
loading an updated code image into memory;
restoring the data structures from a persistent memory; and
converting at least one data structure to a current format.

17. The system of claim 16, wherein loading data structures from a persistent memory comprises invoking a restore function associated with a software component.

18. The system of claim 16, further comprising branching to the updated code image.

19. The system of claim 16, further comprising registering the selected data structures.

20. The system of claim 16, wherein converting at least one data structure to a current format comprises deleting at least one field.

21. The system of claim 16, wherein converting at least one data structure to a current format comprises modifying at least one field.

22. An apparatus for updating software while preserving system state, the apparatus comprising:
means for copying selected data structures to a persistent memory;
means for registering the selected data structures;
means for loading an updated code image into memory;
means for restoring the data structures from a persistent memory; and
means for converting at least one data structure to a current format.

23. The system of claim 22, further comprising means for branching to the updated code image.
